(19) United States
(12) Patent Application Publication
(10) Pub. No.: US 2018/0234302 A1
(43) Pub. Date: Aug. 16, 2018

(54) SYSTEMS AND METHODS FOR NETWORK MONITORING

(71) Applicant: QUALCOMM Incorporated, San Diego, CA (US)

(72) Inventors: Arthur James, San Jose, CA (US); Srdjan Miocinovic, Los Gatos, CA (US); Gregory Hobert Joe, San Jose, CA (US); Joel Linsky, San Diego, CA (US); Sandipan Kundu, Santa Clara, CA (US)

(21) Appl. No.: 15/429,482

(22) Filed: Feb. 10, 2017

(51) Int. Cl. H04L 12/24; H04L 12/26; G06N 99/00

(52) U.S. Cl. CPC H04L 41/145; H04L 43/065; H04L 67/12; H04L 41/16; G06N 99/005; H04L 43/062

(57) ABSTRACT

A method is described. The method includes receiving an event monitoring model generated by a machine learning engine. The event monitoring model is configured to classify network device behavior based on observed events. The method also includes monitoring events in a network based on the event monitoring model. Machine learning features are extracted from network traffic generated by one or more network devices. The method further includes determining a network device classification of the monitored events based on the event monitoring model. The method additionally includes sending the observed events and the network device classification to the machine learning engine to update the event monitoring model.

### TECHNICAL FIELD

The present disclosure relates generally to communications. More specifically, the present disclosure relates to systems and methods for network monitoring.

### BACKGROUND

In the last several decades, the use of computing devices has become common. In particular, advances in computing technology have reduced the cost of increasingly complex and useful computing devices. Cost reduction and consumer demand have proliferated the use of computing devices such that they are practically ubiquitous in modern society. As the use of computing devices has expanded, so has the demand for new and improved features of computing devices. More specifically, computing devices that perform new functions and/or that perform functions faster, more efficiently or more reliably are often sought after.

Network monitoring is important to ensure continuous, proper and secure functioning of networks. For example, an internet of things (IoT) or industrial IoT (IIoT) network is a heterogeneous environment with devices from different vendors. Today, after initial authentication, ongoing surveillance of devices does not occur. In the case of IoT devices, the use of trusted computing-based features is not a feasible solution as IoT devices may lack in power and processing ability. Systems and methods for machine learning-based network monitoring may be beneficial.

### SUMMARY

A method is described. The method includes receiving an event monitoring model generated by a machine learning engine. The event monitoring model is configured to classify network device behavior based on observed events. The method also includes monitoring events in a network based on the event monitoring model. Machine learning features are extracted from network traffic generated by one or more network devices. The method further includes determining a network device classification of the monitored events based on the event monitoring model. The method additionally includes sending the observed events and the network device classification to the machine learning engine to update the event monitoring model.

The machine learning engine may receive observed events and network device classifications from a plurality of network devices. The machine learning engine may learn and generate the event monitoring model based on the observed events and the network device classifications received from the plurality of network devices. The machine learning engine may use the observed events and the network device classifications received from the plurality of network devices to perform semi-supervised learning to generate the event monitoring model.

The machine learning engine may learn and generate the event monitoring model for a subset of network devices to be monitored. The machine learning engine may apply the event monitoring model across a group of networks, a group of gateways or a group of nodes within a network. The method may include applying different machine learning models to different sections of a network. The event monitoring model may configure which events are monitored and which machine learning features are extracted from the monitored events.

The machine learning engine may run multiple machine learning algorithms sequentially to generate the event monitoring model for a network device or a group of network devices. The machine learning engine may generate different event monitoring models for different network devices or a same network device with different time information using the same machine learning algorithm with different parameters.

The method may also include receiving an updated event monitoring model in response to sending the observed events and the network device classification to the machine learning engine. The method may further include monitoring events in the network based on the updated event monitoring model.

The method may also include receiving a plurality of event monitoring models from the machine learning engine. A given event monitoring model may configure monitoring of events on a certain subset of network devices. The method may further include monitoring events in a network based on the plurality of event monitoring models.

Monitoring events may include observing network traffic communicated between nodes or network traffic communicated between a node and a gateway.

Monitoring events may include sending a network query to a given network device. Actions taken by the given network device in response to the network query may be observed. The network device classification of the given network device may be determined by applying the event monitoring model to the observed actions.

The method may be implemented at a gateway or a cloud server that receives a traffic feed from a plurality of nodes.

The method may also include limiting behavior of a network device that is classified as rogue or suspicious.

A computing device is also described. The computing device includes a processor, a memory in communication with the processor and instructions stored in the memory. The instructions are executable by the processor to receive an event monitoring model generated by a machine learning engine. The event monitoring model is configured to classify network device behavior based on observed events. The instructions are also executable to monitor events in a network based on the event monitoring model. Machine learning features are extracted from network traffic generated by one or more network devices. The instructions are further executable to determine a network device classification of the monitored events based on the event monitoring model. The instructions are additionally executable to send the observed events and the network device classification to the machine learning engine to update the event monitoring model.

A non-transitory tangible computer readable medium storing computer executable code is also described. The computer executable code includes code for causing a computing device to receive an event monitoring model generated by a machine learning engine. The event monitoring model is configured to classify network device behavior based on observed events. The computer executable code also includes code for causing the computing device to monitor events in a network based on the event monitoring model. Machine learning features are extracted from network traffic generated by one or more network devices. The computer executable code further includes code for causing the computing device to determine a network device classification of the monitored events based on the event monitoring model. The computer executable code additionally includes code for causing the computing device to send the observed events and the network device classification to the machine learning engine to update the event monitoring model.

An apparatus is also described. The apparatus includes means for receiving an event monitoring model generated by a machine learning engine. The event monitoring model is configured to classify network device behavior based on observed events. The apparatus also includes means for monitoring events in a network based on the event monitoring model. Machine learning features are extracted from network traffic generated by one or more network devices. The apparatus further includes means for determining a network device classification of the monitored events based on the event monitoring model. The apparatus additionally includes means for sending the observed events and the network device classification to the machine learning engine to update the event monitoring model.

### BRIEF DESCRIPTION OF THE DRAWINGS

FIG. 1 is a block diagram illustrating a mesh network configuration;

FIG. 2 is a block diagram illustrating a system configured for network monitoring;

FIG. 3 is a flow diagram illustrating a method for network monitoring;

FIG. 4 is a block diagram illustrating a configuration of a system for network monitoring;

FIG. 5 is a flow diagram illustrating another configuration of a method for network monitoring;

FIG. 6 is a block diagram illustrating a top-level network monitoring framework;

FIG. 7 is an example illustrating an internet of things (IoT) hierarchical network topology;

FIG. 8 is an example illustrating a first event monitoring model configuration;

FIG. 9 is an example illustrating a second event monitoring model configuration;

FIG. 10 is an example illustrating a third event monitoring model configuration;

FIG. 11 is a block diagram illustrating one configuration of a feature extractor; and

FIG. 12 illustrates certain components that may be included within a computing device.

### DETAILED DESCRIPTION

Monitoring is important to ensure continuous, proper functioning of a network. Network monitoring may be employed for different use cases and in different types of networks. For example, different use cases may include security, home automation and energy management. Some of the different types of networks that may benefit from network monitoring include Internet of Things (IoT) networks, industrial IoT (IIoT) networks, automotive networks for Bluetooth, ZigBee, WiFi, CSR mesh, etc.

An IoT network (also referred to as a mesh network) presents particular challenges for network monitoring. An IoT network is a heterogeneous environment with devices from different vendors. Today, after initial authentication, ongoing surveillance of devices does not occur. Use of trusted computing based features (e.g. secure execution environment, input/output (I/O), storage, etc.) is not a feasible solution as IoT devices may lack in power and processing ability. These abilities may increase the cost of IoT devices.

Additionally, new malware applications can be injected into a network after authentication. Rogue devices may remain dormant for long periods before activation. Therefore, customized data-driven surveillance and analysis of each network device and network behavior may be employed to address this problem. The described systems and methods provide monitoring and security against rogue devices by observing their behavior in the network and using machine learning to classify behavior as normal, rogue or suspicious.

The described systems and methods learn the normal behavior in a specific network environment. Behavioral data from the environment is used in a machine learning (ML) system that observes the behavior of network devices (e.g., IoT nodes, gateways, etc.) and classifies them as “normal” or “rogue” devices. Some key steps include feature definition in which behavior of IoT devices in the network is extracted by surveillance of network activity. This may be achieved by observing an event flow of the network at the gateways. Additionally, the actions taken by IoT devices may be observed in response to communications with users, gateways and other IoT devices. Additional custom device actions (if available) may also be observed.

Some of the benefits of the described systems and methods include network monitoring that is data-driven. Hence, this fits the custom nature of various IoT network use cases. The described systems and methods also provide continuous security through surveillance. This does not require any change in the underlying IoT device or the network protocol. These solutions are very scalable with respect to the size of the IoT network and application layer models. Furthermore, these systems and methods are applicable to a variety of networks, including IoT and automotive.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

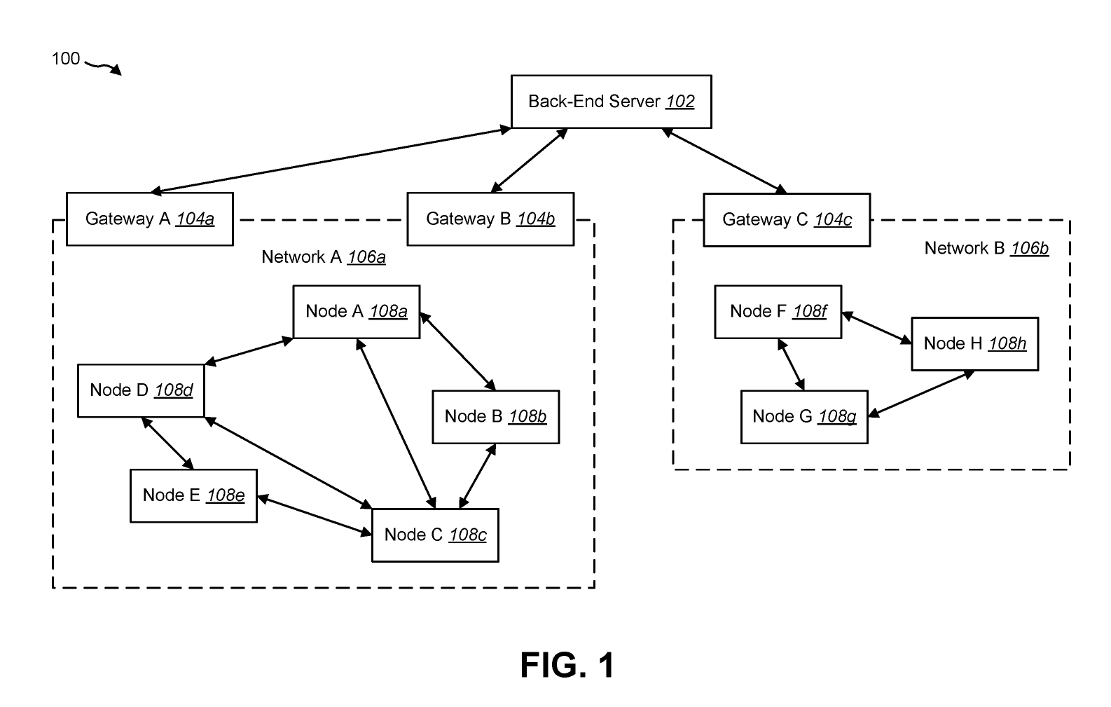

FIG. 1 is a block diagram illustrating a mesh network 106 configuration. A mesh network 106 may include multiple nodes 108. The nodes 108 may be referred to as internet of things (IoT) devices, TOT nodes or mesh nodes, depending on the technology underneath it. A mesh network 106 may also be referred to as an IoT network. Examples of a mesh network 106 include CSR mesh networks and ZigBee networks. In general, these nodes 108 are devices that are configured to communicate together to form a network 106.

The nodes 108 may be wired or wireless communication devices. A wireless communication device may utilize one or more communication technologies or protocols. For example, one communication technology may be utilized for mobile wireless system (MWS) (e.g., cellular) communications, while another communication technology may be utilized for wireless connectivity (WCN) communications. MWS may refer to larger wireless networks (e.g., wireless wide area networks (WWANs), cellular phone networks, Long Term Evolution (LTE) networks, Global System for Mobile Communications (GSM) networks, code division multiple access (CDMA) networks, CDMA2000 networks, wideband CDMA (W-CDMA) networks, Universal mobile Telecommunications System (UMTS) networks, Worldwide Interoperability for Microwave Access (WiMAX) networks, etc.). WCN may refer to relatively smaller wireless networks (e.g., wireless local area networks (WLANs), wireless personal area networks (WPANs), IEEE 802.11 (Wi-Fi) networks, Bluetooth (BT) networks, IEEE 802.15.4 (e.g., ZigBee) networks, wireless Universal Serial Bus (USB) networks, etc.). In one approach, a mesh network 106 may use Bluetooth as the underlying radio technology to communicate between devices.

A node 108 may also be referred to as a wireless device, a mobile device, mobile station, subscriber station, client, client station, user equipment (UE), remote station, access terminal, mobile terminal, terminal, user terminal, subscriber unit, etc. Examples of nodes 108 include laptop or desktop computers, cellular phones, smartphones, wireless modems, e-readers, tablet devices, gaming systems, keyboards, keypads, computer mice, remote controllers, headsets, thermostats, smoke detectors, sensors, etc.

Gateways 104 may be added to provide complete coverage to a mesh network 106. In this example, two gateways 104a-b provide coverage to the nodes 108a-e in a first mesh network 106a. Another gateway 104c provides coverage to nodes 108f-h in a second mesh network 106b. The back-end server 102 may provide device configuration, credentials and policies.

In one network topology, the nodes 108 themselves can connect directly to the cloud (i.e., back-end server 102). For example, a mobile device may be a node 108 that has a WiFi connection and can connect directly with the back-end server 102.

In another network topology, there is a large class of IoT devices that are constrained devices. For example, the nodes 108 may have limited microcontrollers and memory. These nodes 108 may be cheaper as well, but they are also less secure. In this network topology, a gateway 104 proxy is needed between the back-end server 102 and the mesh nodes 108.

Security is important to ensure continuous, proper functioning of mesh networks 106. A mesh network 106 is a diverse environment that may include devices from different vendors. After initial authentication, ongoing surveillance of devices may not occur. A trusted computing-based security (e.g. secure execution environment, I/O, storage, etc.) is not a feasible solution as IoT nodes 108 may lack in power and processing ability. The introduction of trusted computing features increases the cost of IoT devices and is expensive in an Industrial IoT (IIoT) setting.

In an example of a security challenge with mesh networks 106, a node 108 may be a camera that gets hacked. A premise of mesh networks 106 is to function on a standalone basis. The nodes 108 may be out in the field in a remote location. Security is a critical component. Because the mesh networks 106 are usually made from devices from different vendors, they might not all be implemented the same way. The nodes 108 might not all be secure. For example, some vendors might take shortcuts. When a consumer puts these devices out in their home or in an enterprise, or in cases of smart cities where these nodes 108 are deployed out in the field, security becomes an important issue.

In a computing-based security approach, security may consider a semi-connected chip where there is security underlying the capabilities of the chip. For example, some computing-based security considerations are whether the node 108 has secure storage, a secure execution environment, secure I/O, and a secure boot procedure. These are features that may be provided by the chip. But these features are expected to be used by an application to harden the node 108 and prevent hackers from getting access to the node 108 itself. One problem is that some of these chips do not have these features. They are more easily hackable than others. Even if these features are available on chips, they may not be used. Therefore, there may be a whole host of devices in a mesh network 106 whose security may be unknown.

Furthermore, new malware applications can be injected in a mesh network 106 after authentication. The network configuration changes frequently, hence traditional network monitoring solutions will fail. Also, rogue devices may remain dormant for long periods before activation. Therefore, an important challenge is providing security against rogue IoT devices (e.g., mesh nodes 108) by observing the behavior of devices in the network.

In many cases, rogue devices stay dormant for a period of time and then come up later and exhibit malicious behavior. Configurations themselves can change very frequently, when a network 106 is first deployed and nodes 108 are replaced later. The replacement might not be as secure as the one that was originally in the network 106. All of these are factors in security challenges.

Another use case for a mesh network 106 includes home automation. For example, nodes 108 in a home automation environment may be automated. However, programing the nodes 108 may be cumbersome for a human user.

Yet another use case for a mesh network 106 includes energy management. For example, nodes 108 may consume power unnecessarily. Therefore, benefits may be gained by automatically putting a node 108 in sleep mode. Furthermore, to maintain system efficiency, nodes 108 that are not functioning properly may be identified and corrected via the network monitoring described herein.

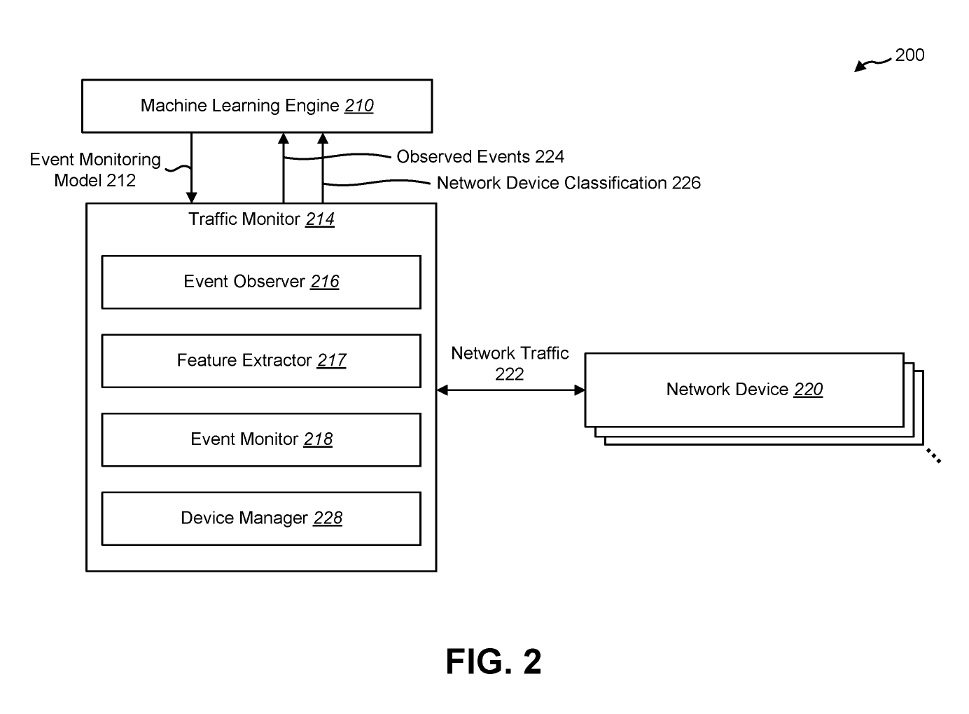

FIG. 2 is a block diagram illustrating a system 200 configured for network monitoring. The system 200 may include a traffic monitor 214 and a machine learning engine 210.

As described above, network monitoring is important for continuous, proper functioning of networks 106. Furthermore, mesh networks 106 provide additional challenges. The systems and methods described herein provide monitoring of one or more networks 106.

The traffic monitor 214 may be configured to receive network traffic 222 from one or more network devices 220. In an implementation, the network devices 220 may be part of a mesh network 106. For example, the network devices 220 may be nodes 108 in a CSR mesh network. In an approach, the traffic monitor 214 may be implemented in a gateway 104 of a network 106. In another approach, the traffic monitor 214 may be implemented in a back-end server 102. For example, the traffic monitor 214 may receive network traffic 222 from one or more network devices 220 over the internet. In this approach, the network devices 220 may include nodes 108, gateways 104 and other devices (e.g., routers, domain servers, etc.).

The machine learning engine 210 may be implemented in a back-end server 102. For example, the machine learning engine 210 may be included in a machine learning-based event analyzer service hosted on a back-end server 102. In an implementation, the machine learning engine 210 may be cloud-based. The machine learning engine 210 may be configured to communicate with one traffic monitor 214 or a plurality of traffic monitors 214 from different networks 106.

The described systems and methods provide a data-driven behavior-based machine learning (ML) solution that observes behavior of network devices 220 (e.g., IoT devices) and classifies them as normal or rogue devices. This network monitoring includes feature extraction. Some key feature extraction steps may include extracting behavior of network devices 220 in the network 106 by surveilling network activity. Event flow of the network 106 may be observed at the gateways 104 or back-end server 102. For example, the event flow may include packets communicated between the nodes 108 and gateways 104. Behavior of the network may also be extracted by observing the actions taken by nodes 108 in response to communications with users, gateways 104 and other network devices (e.g., other nodes 108, routers, etc.). Additional device actions may be observed (if available).

The systems and methods are described in terms of a CSR mesh network. For example, the systems and methods provide feature vectors (e.g., observation events) that are important to the performance of behavior-based ML security in a CSR mesh network. However, it should be noted that the systems and methods described herein may be applied to other types of networks (e.g., IoT networks, IIoT networks, Automotive for Bluetooth, ZigBee, WiFi, etc.).

The traffic monitor 214 and the machine learning engine 210 may be used to monitor a network 106. To ensure a secure network 106, it is important to know that a network device 220 is secure at any point in its life cycle. For example, a network device 220 might seem secure at first, but it may be a rogue device that is not really secure. A complete network monitoring approach does not simply authenticate a network device 220 and then forget about it afterwards. Instead, the traffic monitor 214 and machine learning engine 210 can analyze data from a network device 220 by observing network traffic 222. Therefore the traffic monitor 214 and machine learning engine 210 may watch a network 106 day in and day out to determine if the network 106 is being compromised by some rogue device or not.

The systems and methods describe a data-driven approach. The behavior of the network devices 220 is analyzed. Then, a network device 220 may be classified as normal, rogue or suspicious. This process involves machine learning to adapt to custom use cases. For example, what might be anomalous behavior in one system may not be anomalous in another system. Therefore, the network monitoring system 200 has to learn normal behavior of a network device 220 as a reference baseline, and then identify any behavior from network devices 220 that do not conform to that norm. If a network device 220 is classified as rogue or suspicious, that network device 220 may be subject to further investigation.

The traffic monitor 214 may include an event observer 216 that receives network traffic 222. The events 224 are data obtained from the network traffic 222. The event observer 216 may be configured to observe certain network activity. For example, the event observer 216 may observe packets communicated between nodes 108 and gateways 104. The event observer 216 may also observe actions taken by nodes 108 in response to communications with users, gateways 104 and other nodes 108. In an implementation, the traffic monitor 214 may query a network device 220 to obtain information about the identity and behavior of the network device 220.

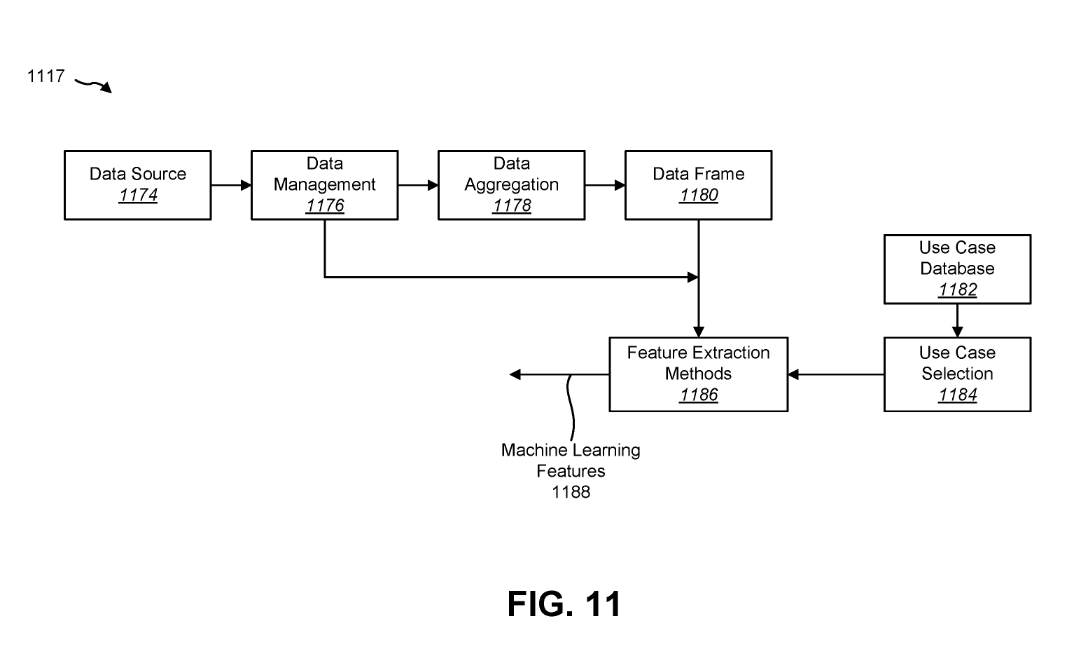

The choice of events 224 that are observed is critical to system performance. The observed events 224 may include communications between network devices 220 and a gateway 104. Different application layer models are described in connection with FIG. 11. The observed events 224 may also include communications between one network device 220 and another network device 220. For example, an IoT device may shut down a critical network application (e.g., a security camera, front door lock, etc.).

The observed events 224 may also include actions of network devices 220. For example, a gateway 104 may issue a command to a node 108. The event observer 216 may note when a node 108 refuses to acknowledge the command. Additionally, a user may send a command to a node 108 and the event observer 216 may observe the response.

The observed events 224 may also include actions of network devices 220 taken by themselves. For example, the event observer 216 may observe periodic connection to gateways 104 or connection to a server (on a gateway or cloud, for instance) for updates. The event observer 216 may also observe a network device 220 trying to connect to an unknown server.

In an implementation where the traffic monitor 214 is included in a gateway 104, the event observer 216 may observe the communications in the network 106 to which the gateway 104 belongs. General communications that happen between nodes 108 and the gateway 104 happen over the air. Therefore, if the gateway 104 is part of the network 106, the traffic monitor 214 can just observe the network traffic 222 and this has no performance implications on the network devices 220. In other words, the network devices 220 may perform normal operations and the traffic monitor 214 collects the data. For example, the traffic monitor 214 may observe when packets are sent and to whom packets are sent (i.e., what is the source device).

The observed events 224 may also include side channel information. For example, gateways 104 are able to integrate with other sources of information obtainable from the device it is deployed on. These provide additional input beyond what can be observed from a mesh network 106. For example, a security gateway 104 deployed in a WiFi router may use information from the router to inform the event monitor 218 of device authentication requests that are connecting over Wi-Fi. This may be accomplished through an API on the router (as a side channel). The number of failures of these requests may serve as an additional feature for detecting an attack.

In addition to passive observation, the traffic monitor 214 may query the network device 220 to obtain additional information. Queries may have implications on the performance of the network device 220. If a query is performed too many times, network device 220 performance may be compromised. Therefore, the traffic monitor 214 may schedule a query to a network device 220. The observed events 224 may include the response coming back from the network device 220 itself or whether the network device 220 refused to respond to a query.

The event observer 216 may send observed events 224 to the machine learning engine 210. For example, the event observer 216 may send a raw network traffic 222 feed to the machine learning engine 210. In another approach, the event observer 216 may send a subset of the network traffic 222 to the machine learning engine 210.

A feature extractor 217 may extract machine learning features from the observed events 224. A machine learning feature is a combination of observed events 224. A machine learning feature may also be referred to as a feature or a feature vector. In an example, the event observer 216 may observe that something is accessing a particular network device 220 repeatedly late at night. A combination of all of these events may form a machine learning feature that is suspicious. Any one data point by itself may not be necessarily suspicious, but a combination of these acts form a pattern that might be suspicious. An example of a feature extractor 217 is described in connection with FIG. 11.

An important consideration for network monitoring is speed and performance. As observed events 224 are evaluated, they have to be evaluated at a high throughput, because every event has to be organized as part of a machine learning feature. With behavior-based security, the traffic monitor 214 cannot take the time to run if-then rules. Instead, the traffic monitor 214 achieves a high throughput by extracting machine learning features from the observed events 224 and evaluating the machine learning features against an event monitoring model 212 provided by the machine learning engine 210. This ensures that the performance is not compromised.

The type of machine learning features that are extracted may be configurable. The traffic monitor 214 may collect different data for different types of networks 106. The feature extractor 217 may create different machine learning features depending on the type of network 106 and the use cases (e.g., security, home automation, energy management, etc.). In an example, the traffic monitor 214 may be configured to monitor a CSR mesh network for a security use case.

The machine learning engine 210 may learn and generate the event monitoring models 212. The machine learning engine 210 may use semi-supervised learning, unsupervised learning and similar techniques to generate the event monitoring model 212. This may be a continuous process. For example, the machine learning engine 210 may learn normal behavior of a network 106 using machine learning training sets. The machine learning engine 210 may then generate an event monitoring model 212.

In an implementation, the machine learning engine 210 (i.e., the back-end algorithm for generating the event monitoring model 212 to classify network devices 220) may use decision trees or decision trees with boosting. For example, the machine learning engine 210 may use adaptive boosting (AdaBoost), gradient boost or boosting with tree pruning. Alternatively, the machine learning engine 210 may use k-means clustering to generate the event monitoring model 212. The machine learning engine 210 may also use one or more anomaly detection tests (e.g., Grubb test, 3-sigma test, median absolute deviation (MAD) test, etc.).

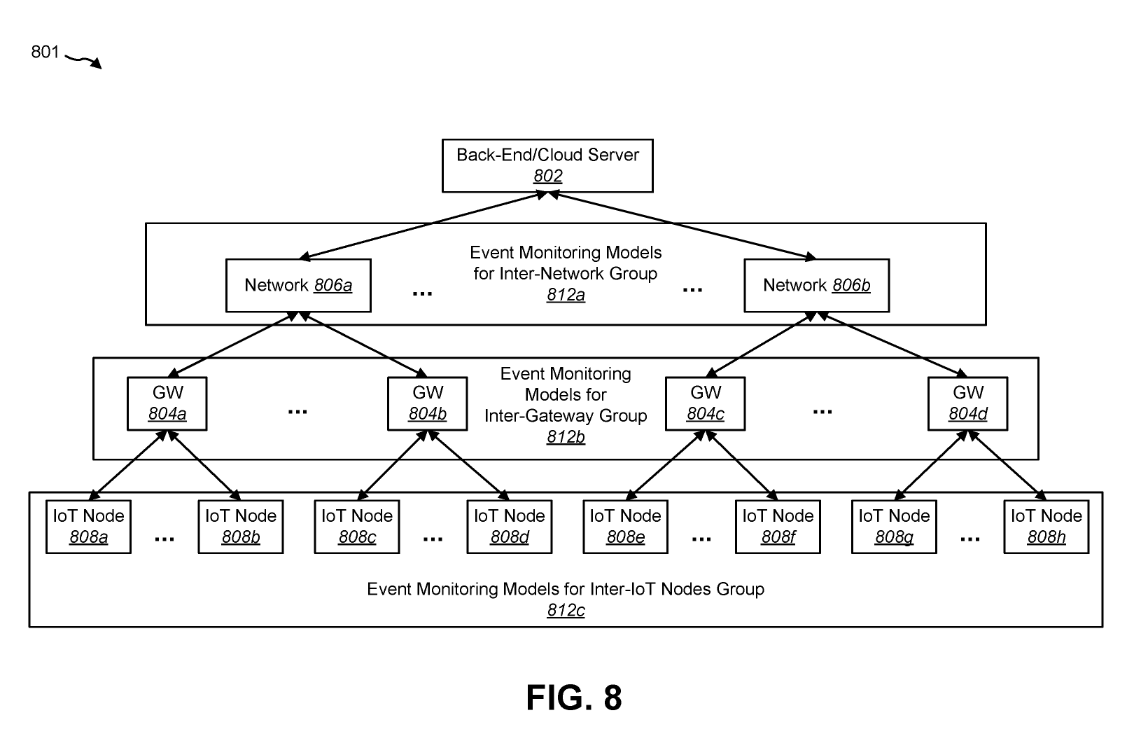

In an implementation, the machine learning engine 210 learns and generates the event monitoring model 212 for a subset of network devices 220 to be monitored. Different machine learning model configurations are described in connection with FIGS. 8-10.

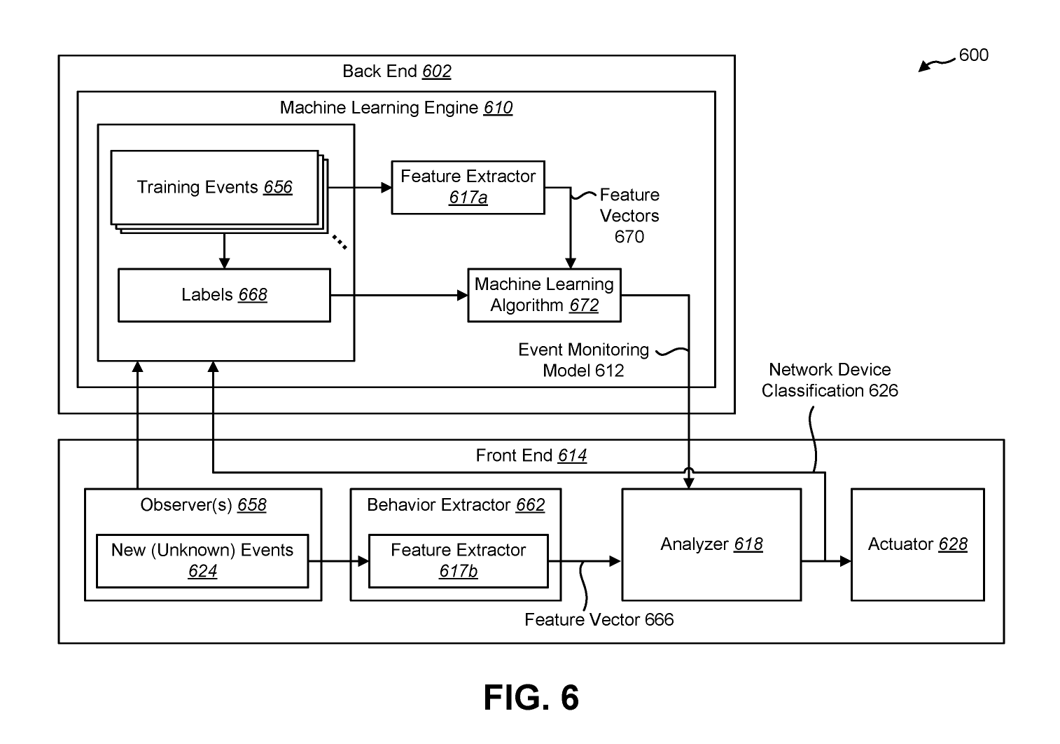

The machine learning engine 210 may be configured to continuously learn from information provided by one or more traffic monitors 214. Therefore, the traffic monitor(s) 214 may observe data that is generated on the networks 106, and provide the observed events 224 to the machine learning engine 210. The machine learning engine 210 may then update the event monitoring models 212 of anomalies on the cloud. The updated event monitoring models 212 are then pushed down to the traffic monitor(s) 214 (e.g., gateway 104). An example of how the machine learning engine 210 generates an event monitoring model 212 is described in connection with FIG. 6. The event monitoring model 212 may configure which events are monitored by the traffic monitor(s) 214 and the features extracted from the observed events 224.

Upon receiving an event monitoring model 212 from the machine learning engine 210, the traffic monitor 214 may configure an event monitor 218 to monitor events in a network 106 based on the event monitoring model 212. The event monitor 218 may receive the machine learning features extracted from the observed events 224 from the feature extractor 217. The event monitor 218 may apply the machine learning features to the event monitoring model 212.

The event monitor 218 may determine a network device classification 226 of the observed events 224 based on the event monitoring model 212. Using the configured event monitoring model 212, the event monitor 218 may classify a behavior of a network device 220 as normal, rogue or suspicious. For example, the event monitor 218 may apply the machine learning features to the event monitoring model 212 to identify normal behavior or rogue behavior. As used herein, normal behavior is behavior that is within acceptable parameters. Rogue behavior is behavior that is outside acceptable parameters. For example, rogue behavior may be known malicious behavior. Rogue behavior may also be behavior that is known to fall outside standard operations exhibited by a network device 220. If the event monitoring model 212 is unable to determine a normal or rogue behavior, those observed events 224 may be considered suspicious and may be further analyzed. It should be noted that the analysis of network device 220 behavior can be done at a gateway 104 as well as at a cloud-based back-end server 102.

The traffic monitor 214 may send the observed events 224 and network device classifications 226 to the machine learning engine 210. The machine learning engine 210 may then update the labels on the observed events 224 in a semi-supervised fashion. The machine learning engine 210 may update the event monitoring model 212 using this information provided by the traffic monitor 214.

The machine learning engine 210 may send an updated event monitoring model 212 to one or more traffic monitors 214. Upon receiving the updated event monitoring model 212, the event monitor 218 may monitor events in the network 106 based on the updated event monitoring model 212. In this manner, the network monitoring may continue to adapt to changing conditions. Also, the machine learning engine 210 may continue to learn the behavior of the network devices 220 to improve the event monitoring model 212.

A device manager 228 may respond to the classification of the event monitor 218. For example, if the event monitor 218 detects rogue or suspicious behavior, the event monitor 218 may issue an alert. The device manager 228 may limit behavior of rogue or suspicious network devices 220. For example, the device manager 228 may remove a rogue network device 220 from the network 106 or disable a rogue network device 220 in some capacity. The device manager 228 may also send a text message (e.g., SMS) or email alert to an administrator.

In an implementation, the machine learning engine 210 may receive observed events 224 and network device classifications from a plurality of network devices 220 or traffic monitors 214. It should be noted that the machine learning engine 210 may not generate one all-encompassing generic event monitoring model 212. The machine learning engine 210 may observe the network traffic 222 in different scenarios and different networks 106. The machine learning engine 210 may use a machine learning algorithm to generate a series of event monitoring models 212 that are provided to one or more traffic monitors 214.

The machine learning engine 210 may generate different event monitoring models 212 for different use cases. For example, the machine learning engine 210 may generate an event monitoring model 212 for a denial of service use case in one particular form of network 106. The machine learning engine 210 may generate event monitoring models 212 for home networks 106, or other event monitoring models 212 for industrial networks 106. The machine learning engine 210 may also generate event monitoring models 212 for an automotive network 106.

Additionally, the machine learning engine 210 may generate different event monitoring models 212 for different network devices 220. Each network device 220 may have its own event monitoring model 212 running on a traffic monitor 214. Therefore, there may not be just one event monitoring model 212 for the whole network 106. Instead, the traffic monitor 214 may apply one event monitoring model 212 for one network device 220 and another event monitoring model 212 for a different network device 220.

It should also be noted that the event monitoring models 212 may not be limited to nodes 108 in a mesh network 106. Instead, the event monitoring models 212 may be applied to gateways 104. For example, in an industrial situation where there are multiple gateways 104, the learning process may be applied to a machine learning engine 210 to detect the behavior of the multiple gateways 104. The machine learning engine 210 may look at all the network traffic 222 from the nodes 108 and the gateways 104 to learn the behavior of a whole network 106. Therefore, the event monitoring models 212 may be used for the whole network 106.

The machine learning engine 210 may select an event monitoring model 212 to provide to a given traffic monitor 214 based on the use case for which the event monitoring models 212 are learned and generated. In a security use case, the event monitoring model 212 is learned after a period of observation of security related features. Anomalies that deviate from the pattern are then detected. In a home automation use case, the usage of network devices 220 is observed for a period of time and then automation of such usage can be provided. In an energy management use case, usage of network devices 220 may be observed and network devices 220 may be automatically put in sleep mode. In addition to these examples, other use cases may also be implemented.

The machine learning engine 210 may perform semi-supervised learning from the plurality of network traffic sources. Therefore, the machine learning engine 210 may receive different kinds of observed events 224. The machine learning engine 210 may learn the behavior of the network 106 as a whole, not just portions of networks 106 that are observed by a given gateway 104. The machine learning engine 210 may then push an event monitoring model 212 for a given network device 220 or a group of network devices 220 (e.g., two gateways 104 and multiple nodes 108).

Because the machine learning engine 210 may generate event monitoring models 212 based on network traffic 222 from multiple traffic monitors 214, a given traffic monitor 214 may receive an event monitoring model 212 that captures network behavior that goes beyond what any single traffic monitor 214 can observe. Upon receiving the event monitoring model 212, the traffic monitor 214 may monitor for this previously learned behavior.

In another implementation, the traffic monitor 214 may be in the cloud (e.g., on the back-end server 102). In this implementation, the traffic monitor 214 may do further analysis. The traffic monitor 214 may monitor behavior across multiple gateways 104. Therefore, the traffic monitor 214 may observe that a particular network 106 location is targeted by a security attack, or the location might be a zip code, or a state based on where the network traffic 222 is coming from.

Some important aspects of the described systems and methods include continuous surveillance framework for ad-hoc mesh networks (agnostic of PHY and MAC protocol). Flexibility is provided for supporting, upgrading and applying multiple machine learning models and statistical tests in front end surveillance devices like gateways 104. Key observation points and features are described that may be monitored and extracted for providing continuous security in a mesh network (e.g., CSR mesh, Bluetooth Special Interest Group (SIG) mesh and ZigBee).

The described systems and methods provide a data-driven solution. This fits the custom nature of various network 106 use cases, especially mesh networks. The described systems and methods also provide continuous security through surveillance without requiring any changes in the underlying network device 220 (e.g., IoT device) or the network protocol.

The described systems and methods are very scalable with regards to the size of the IoT network 106 and application layer models. These solutions are applicable to a variety of networks including IoT and automotive networks. Since the solution is data-driven and derives the normal, rogue or suspicious classifications by analyzing node behaviors, there is no need to physically examine a node, its program or data memory to recognize threats. This is in contrast to traditional malware detection, which requires examination of the memory representation of rogue program code, typically in binary form.

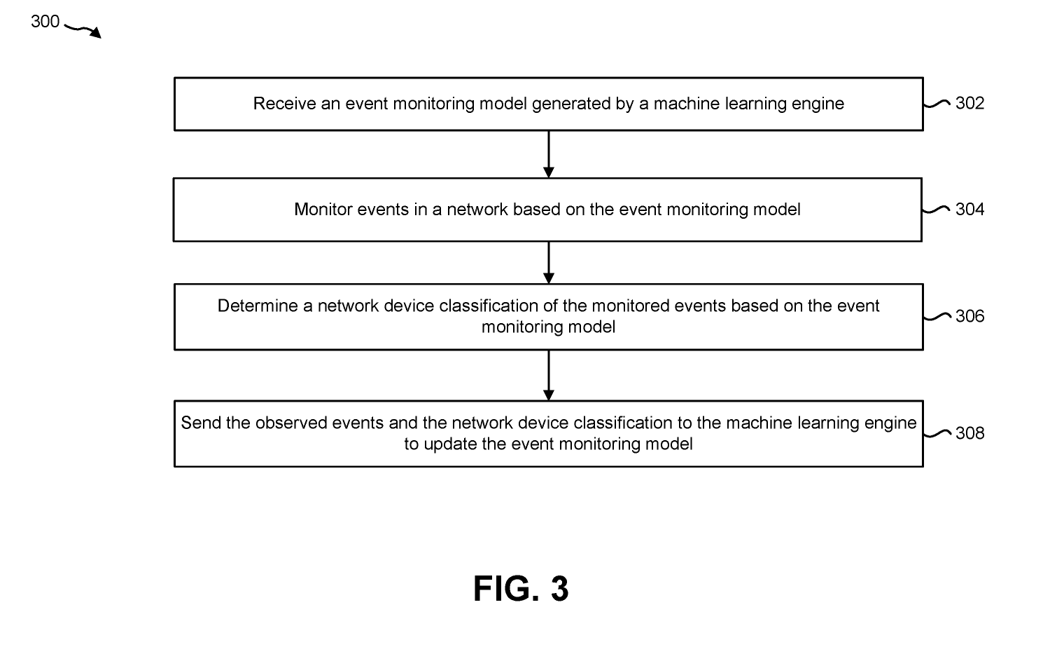

FIG. 3 is a flow diagram illustrating a method 300 for network monitoring. The method 300 may be implemented by a traffic monitor 214 that is configured to receive network traffic 222. In one implementation, the traffic monitor 214 may be included in a gateway 104. In another implementation, the traffic monitor 214 may be included in a back-end server 102 that receives a traffic feed from a plurality of nodes 108.

The traffic monitor 214 may receive 302 an event monitoring model 212 generated by a machine learning engine 210. The event monitoring model 212 may be configured to classify network device 220 behavior based on observed events 224. For example, the machine learning engine 210 may apply a machine learning algorithm for classification. Examples of the machine learning algorithm include decision trees, decision trees with boosting (e.g., AdaBoost, Gradient boost, Boosting with tree pruning) and K-means.

The traffic monitor 214 may monitor 304 events 224 in a network 106 based on the event monitoring model 212. For example, the traffic monitor 214 may observe events 224 in the network traffic 222 generated by one or more network devices 220. The traffic monitor 214 may observe network traffic 222 communicated between nodes 108 or network traffic 222 communicated between a node 108 and a gateway 104. The traffic monitor 214 may also monitor 304 actions taken by a node 108 in response to a network query. The event monitoring model 212 may configure which events 224 are monitored and the features extracted from the monitored events 224. The traffic monitor 214 may extract machine learning features from the network traffic 222.

In an implementation, the traffic monitor 214 may receive 302 a plurality of event monitoring models 212 from the machine learning engine 210. A given event monitoring model 212 may configure monitoring 304 of events 224 on a certain subset of network devices 220.

The traffic monitor 214 may determine 306 a network device classification 226 of the monitored events 224 based on the event monitoring model 212. For example, the traffic monitor 214 may apply the extracted machine learning features to the event monitoring model 212 to determine whether a given network device 220 has behavior that is normal (e.g., good), rogue (e.g., bad) or suspicious.

The traffic monitor 214 may limit behavior of a network device 220 that is classified as rogue or suspicious. For example, the traffic monitor 214 may remove a rogue device from a network 106.

The traffic monitor 214 may send 308 the observed events 224 and the network device classification 226 to the machine learning engine 210 to update the event monitoring model 212. The machine learning engine 210 may receive observed events 224 and network device classifications 226 from a plurality of network devices 220. For example, the machine learning engine 210 may receive observed events 224 and network device classifications 226 from multiple traffic monitors 214 or directly from network devices 220.

The machine learning engine 210 may learn and generate the event monitoring model 212 sent to a given traffic monitor 214 based on the observed events 224 and the network device classification 226 received from the plurality of network devices 220 and traffic monitors 214. The machine learning engine 210 may use the observed events 224 and the network device classification 226 received from the plurality of network devices 220 and traffic monitors 214 to perform semi-supervised learning to generate the event monitoring model 212.

In an implementation, the machine learning engine 210 may learn and generate the event monitoring model 212 for a subset of network devices 220 to be monitored. For example, the machine learning engine 210 may apply the event monitoring model 212 across a group of networks 106, a group of gateways 104 or a group of nodes 108 within a network 106. The traffic monitor 214 may, therefore, apply different machine learning models 212 to different sections of a network 106.

The traffic monitor 214 may receive an updated event monitoring model 212 in response to sending 308 the observed events 224 and the network device classification 226 to the machine learning engine 210. The traffic monitor 214 may monitor events 224 in a network 106 based on the updated event monitoring model 212.

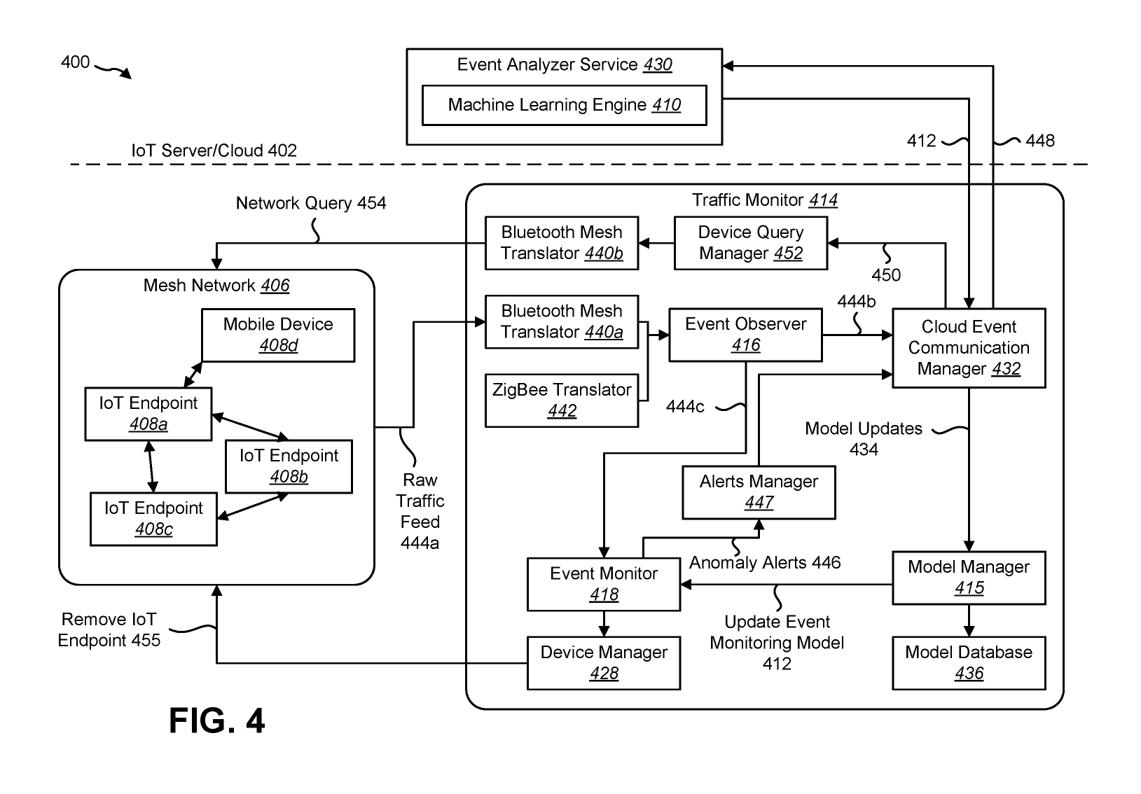

FIG. 4 is a block diagram illustrating a configuration of a system 400 for network monitoring. The system 400 may be implemented in accordance with the system 200 described in connection with FIG. 2. FIG. 4 provides a high level system overview. An example of a gateway-to-cloud traffic monitor architecture is shown. A CSR mesh network 406 is shown as an example, but this approach is applicable to other types of networks such as ZigBee, SIG Mesh, Wi-Fi, Bluetooth, Bluetooth low energy (BLE), etc.

A traffic monitor 414 may communicate with a machine learning-based event analyzer service 430. The event analyzer service 430 may be included in an IoT server or cloud server 402. The event analyzer service 430 may include a machine learning engine 410.

The event analyzer service 430 may send an event monitoring model 412 to a cloud event communication manager 432 of the traffic monitor 414. The event monitoring model 412 may be learned and generated as described in connection with FIG. 2. The event analyzer service 430 may also schedule network queries for the traffic monitor 414 to implement.

The cloud event communication manager 432 may provide model updates 434 to a model manager 415. The model updates 434 may include one or more event monitoring models 412 received from the event analyzer service 430. The model manager 415 may store the model updates 434 in a model database 436. The model manager 415 may update the event monitoring model 412 at an event monitor 418.

The event monitoring models 412 may be self-contained modules. The event monitoring models 412 may contain rules for monitoring traffic. The event monitoring models 412 may also contain code needed for monitoring traffic according to the rules.

The model manager 415 may use the updated event monitoring model 412 to monitor a raw traffic feed 444a received from a mesh network 406. In this example, the mesh network 406 includes multiple IoT endpoints 408a-c and a mobile device 408d, however, other configurations may be implemented. Also in this example, the mesh network 406 is a CSR mesh network.

The traffic monitor 414 may include one or more translators configured for a particular type of mesh network 406. For example, a Bluetooth mesh translator 440a receives the raw traffic feed 444a. The traffic monitor 414 may also include a ZigBee translator 442 configured to translate a traffic feed from a ZigBee network (not shown).

An event observer 416 may receive the raw traffic feed 444a from the Bluetooth mesh translator 440a. The event observer 416 may provide the raw traffic feed 444b to the cloud event communication manager 432. The event observer 416 may also provide the raw traffic feed 444c to the event monitor 418.

The event manager 418 may extract features (e.g., machine learning feature vectors) from the raw traffic feed 444c. The event manager 418 may determine whether one or more of the IoT endpoints 408a-c and/or mobile device 408d is exhibiting normal, rogue or suspicious behavior. For example, the event monitor 418 may apply the extracted features to one or more event monitoring models 412. If the event monitor 418 detects rogue or suspicious behavior, the event monitor 418 may send an anomaly alert 446 to an alerts manager 447. The event monitor 418 may also notify a device manager 428 to remove 455 the rogue device 408 from the mesh network 406.

The alerts manager 447 may forward the anomaly alert 446 to the cloud event communication manager 432. The alerts manager 447 may also send an alert to an administrator (via SMS or email message, for instance).

The cloud event communication manager 432 may send a feedback signal 448 to the event analyzer server 430. The feedback signal 448 may include the raw traffic feed 444b and the anomaly alerts 446. The machine learning engine 410 may use the raw traffic feed 444b and the anomaly alerts 446 to perform semi-supervised learning to update the event monitoring model 412.

The cloud event communication manager 432 may send a query schedule 450 received from the event analyzer service 430 to a device query manager 452. The device query manager 452 (also referred to as a query manager or DQM) may execute queries 454 for one or more of the devices 408 in the mesh network 406 according to the defined query schedule 450. For example, the device query manager 452 may send a query to a Bluetooth mesh translator 440b to generate a network query 454. This network query 454 may be used to obtain information (e.g., model number) on the devices 408. The event monitor 418 may receive the query response and analyze it for normal, rogue or suspicious behavior by applying the event monitoring model 412 to the observed actions.

Therefore, in addition to passively logging all messages to/from network elements (i.e., nodes, gateways, etc.), the monitoring infrastructure may include a device query manager 452 which will actively send specific query messages 454 to nodes 108 and gateways 104 to verify that they send back response messages with the proper format and expected contents. The device query manager 452 will query network elements on a periodic basis (and/or on demand, when so instructed by an administrative user) to verify their ongoing health and proper functioning.

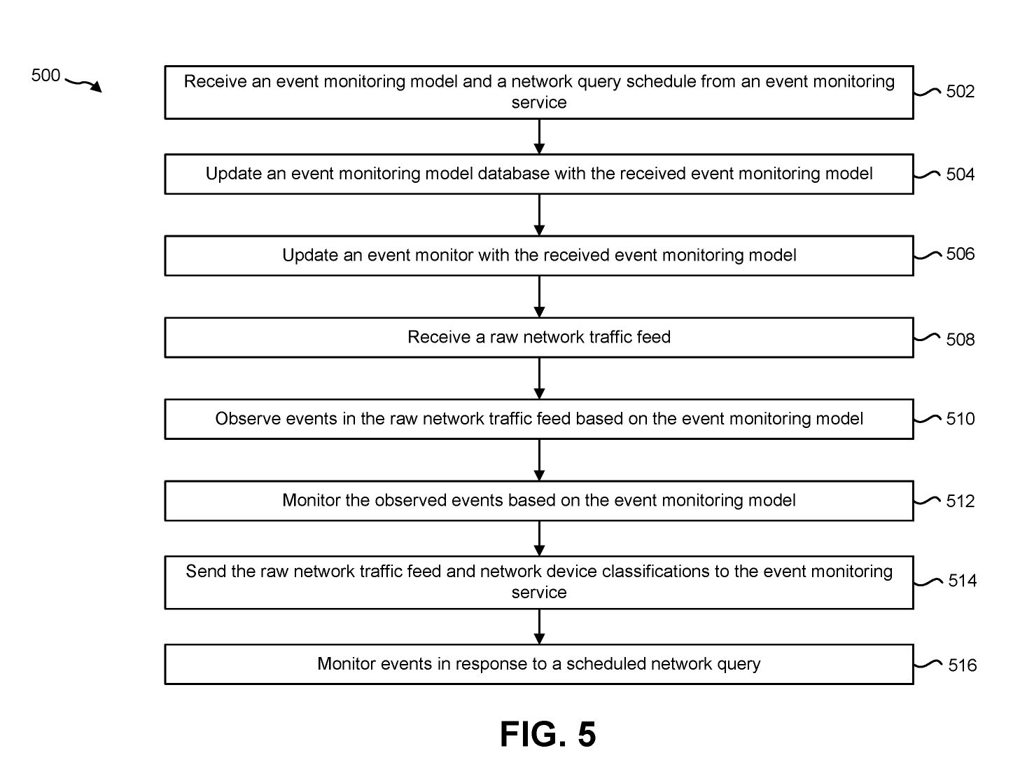

FIG. 5 is a flow diagram illustrating another configuration of a method 500 for network monitoring. The method 500 may be implemented by a traffic monitor 414 that is configured to receive a raw traffic feed from a mesh network 406.

The traffic monitor 414 may receive 502 an event monitoring model 412 and a network query schedule 450 from an event monitoring service 430. The event monitoring service 430 may be implemented by a back-end server 102. In an approach, the back-end server 102 may be a cloud server or IoT server 402. The event monitoring model 412 may be generated by a machine learning engine 410 as described in connection with FIG. 2.

The traffic monitor 414 may update 504 a model database 436 with the received event monitoring model 412. For example, the model database 436 may store multiple event monitoring models 412. The different event monitoring models 412 may be used for different use case scenarios (e.g., security, home automation, automotive, etc.). Different event monitoring models 412 may also be used for different devices 408 in a mesh network 406. The traffic monitor 414 may also update 506 an event monitor 418 with the received event monitoring model 412. For example, a model manager 415 may provide the received event monitoring model 412 to the event monitor 418 to implement monitoring for a given use case.

The traffic monitor 414 may receive 508 a raw network traffic feed 444. For example, the traffic monitor 414 may observe communications (e.g., packets) between nodes and gateways (e.g., between nodes 108 or between a node 108 and a gateway 104).

The traffic monitor 414 may observe 510 events in the raw network traffic feed 444 based on the event monitoring model 412. For example, the event monitoring model 412 may indicate what information should be recorded from the raw network traffic feed 444 for further monitoring. The observed events 224 may include data that is obtained from the raw network traffic feed 444.

The traffic monitor 414 may monitor 512 the observed events 224 based on the event monitoring model 412. Machine learning features may be extracted from the raw network traffic feed 444 as indicated by the event monitoring model 412. The traffic monitor 414 may then apply the event monitoring model 412 to classify network behavior as normal, rogue or suspicious. For example, the traffic monitor 414 may apply decision trees and/or anomaly detection tests (e.g., Grubb test, 3-sigma test, MAD tests) to the extracted features.

The traffic monitor 414 may send 514 the raw network traffic feed 444 and the network device classifications 226 to the event monitoring service 430. The machine learning engine 410 may update the event monitoring model 412 based on this feedback.

The traffic monitor 414 may monitor 516 events 224 in response to a scheduled network query 454. For example, the traffic monitor 414 may send a command to a device 408 in the mesh network 406 according to the network query schedule received 502 from the event monitoring service 430. The traffic monitor 414 may monitor 516 how the queried device 408 responds to the network query 454. The traffic monitor 414 may apply to event monitoring model 412 to this monitored response (or lack of response) to determine normal, rogue or suspicious behavior.

FIG. 6 is a block diagram illustrating a top-level network monitoring framework 600. The framework 600 includes a front end 614 and a back end 602. The front end 614 may be implemented on a gateway 104, a back-end server 102 or cloud-based server. The back end 602 may be implemented on a back-end server 102 or a cloud-based server.

The back end 602 may learn and generate one or more event monitoring models 612. A machine learning engine 610 may receive a plurality of training events 656 with associated known labels 668. The training events 656 may include behavior that is classified as normal and rogue. The labels 668 indicate this classification. The training events 656 may be labeled in a semi-supervised fashion.

A feature extractor 617a may extract machine learning feature vectors 670 from the training events 656. An example of a feature extractor 617a is described in connection with FIG. 11. The feature extractor 617a may provide the feature vectors 670 to a machine learning algorithm 672.

The machine learning algorithm 672 may generate one or more event monitoring models 612 based on the extracted feature vectors 670 and statistical tests on the extracted features 670. In an implementation, multiple machine learning algorithms 672 may be run sequentially to generate an event monitoring model 612 for a network device 220 or a group of network devices 220. In another implementation, different machine learning event monitoring models 612 may be generated for different network devices 220 or the same network device 220 with different time information using the same machine learning algorithm 672 but with different parameters.

The back end 602 may send an event monitoring model 612 to an analyzer 618 of the front end 614. The machine learning algorithm 672 may include decision trees (e.g., AdaBoost, Gradient boost, Boosting with tree pruning), K-means, and/or anomaly detection tests (e.g., Grubb test, 3-sigma test, MAD tests).

The front end 614 may include one or more observers 658. An observer 658 may receive network traffic 222 from one or more network devices 220 in a network 106 (e.g., IoT, IIoT, Automotive for Bluetooth, ZigBee and WiFi). The observer 658 may observe new events 624 in the network traffic 222. These observed events 624 have an unknown classification. The observer 658 may send the observed events 624 to the back end 602. The observer 658 may also provide the observed events 624 to a behavior extractor 662.

The behavior extractor 662 may include a feature extractor 617b. The feature extractor 617b may extract a machine learning feature vector 666 from the observed events 624. It should be noted that the feature extractor 617b of the front end 614 is the same as the feature extractor 617a of the back end 602. Therefore, the feature vector 666 extracted from the observed events 624 by the front end 614 will be the same as the feature vector 670 extracted from the same observed events 624 by the back end 602. The feature vector 666 is provided to an analyzer 618.

The analyzer 618 may apply the event monitoring model 612 to classify the behavior of the observed events 624. For example, the observed events 624 may be classified as normal (i.e., good), rogue (i.e., bad) or suspicious. The analyzer 618 may output the network device classification 626 as a predicted label. The front end 614 may provide the network device classification 626 to the back end 602 to update the event monitoring model 612. This updated learning may be done in a semi-supervised manner.

An actuator 628 may receive the network device classification 626. The actuator 628 may take action based on the network device classification 626. For example, the actuator 628 may remove a rogue device (e.g., a rogue node 108) or send an alert to an administrator.

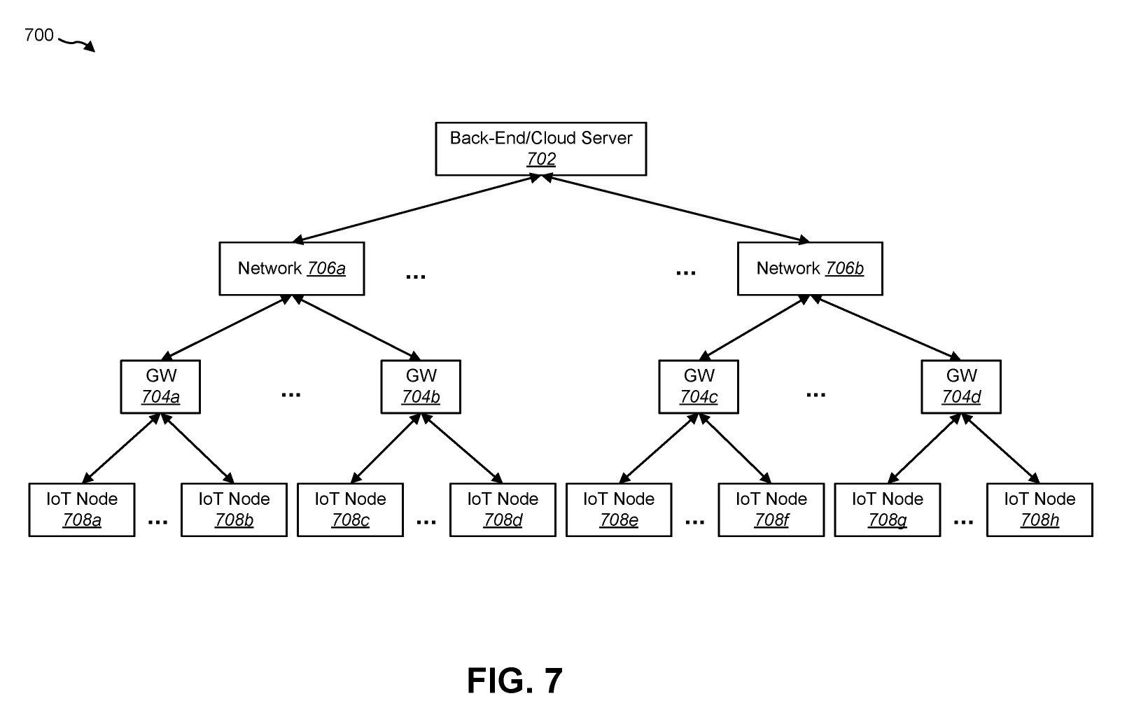

FIG. 7 is an example illustrating an internet of things (IoT) hierarchical network topology 700. A back-end/cloud server 702 may communicate with multiple networks 706a-b. A first network 706a may include multiple gateways (GW) 704a-b that communicate with one or more IoT nodes 708a-d. A second network 706b may include multiple gateways 704c-d that communicate with one or more IoT nodes 708e-h.

A machine learning event monitoring model 212 may be applied to subsets of the IoT network topology 700. For example, an event monitoring model 212 may be applied across the networks 706, gateways 704, IoT nodes 708 or some combination thereof. The event monitoring model 212 may be based on the use case domain where different or multiple event monitoring models 212 may be applied to different sections of the chosen network topology 700. The approach provides behavior-based security for the whole network 706a-b as well as the device level. Different configurations of event monitoring models 212 are described in connection with FIGS. 8-10.

FIG. 8 is an example illustrating a first event monitoring model configuration 801. A back-end/cloud server 802 may communicate with multiple networks 806a-b. A first network 806a may include multiple gateways 804a-b that communicate with one or more IoT nodes 808a-d. A second network 806b may include multiple gateways 804c-d that communicate with one or more IoT nodes 808e-h.

Event monitoring models 812 can be learning and applied independently across different subsets of the IoT network topology. A first event monitoring model 812a may be applied across different groups of networks 804a-b. This first event monitoring model 812a may be for an inter-network group.

A second event monitoring model 812b may be applied across different groups of gateways (GW) 804a-d. This second event monitoring model 812b may be for an inter-gateway group.

A third event monitoring model 812c may be applied across different groups of IoT nodes 808a-h. This third event monitoring model 812c may be for an inter-IoT group.

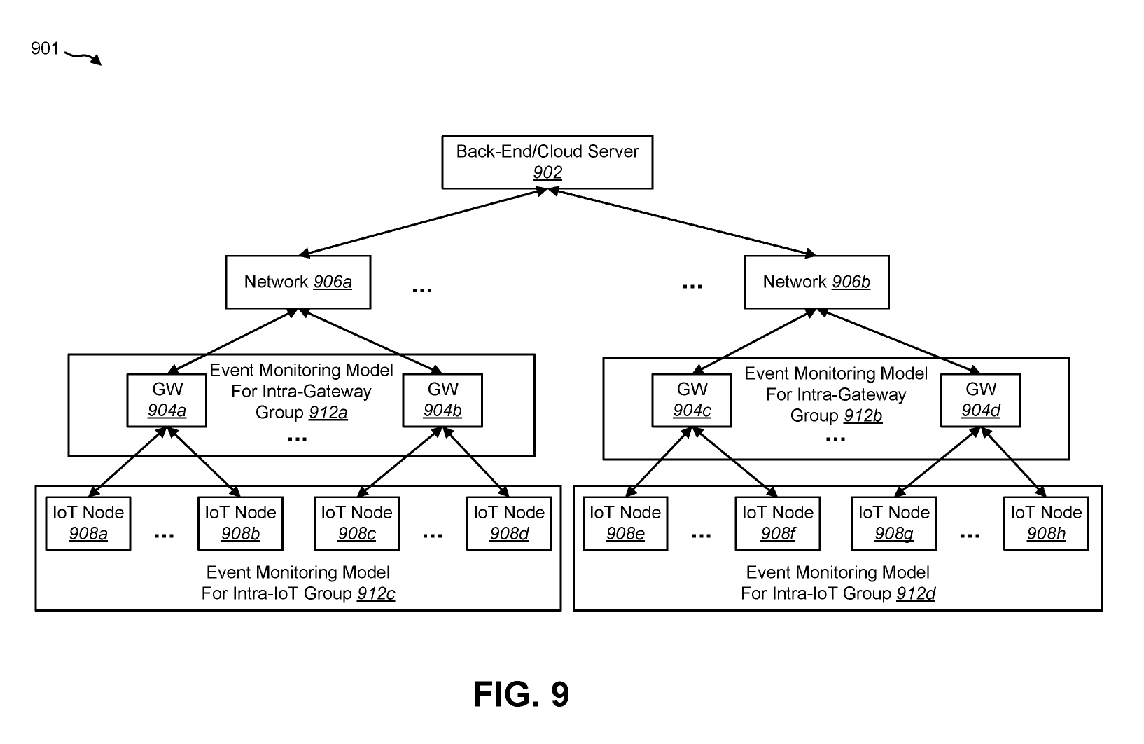

FIG. 9 is an example illustrating a second event monitoring model configuration 901. A back-end/cloud server 902 may communicate with multiple networks 906a-b. A first network 906a may include multiple gateways 904a-b that communicate with one or more IoT nodes 908a-d. A second network 906b may include multiple gateways 904c-d that communicate with one or more IoT nodes 908e-h.

Event monitoring models 912 can be learning and per IoT network 906. An event monitoring model 912 may be applied to different groups of gateways (GW) 904 in an IoT network 906. For example, a first event monitoring model 912a may be applied to a first intra-gateway group. A second event monitoring model 912b may be applied to a second intra-gateway group.

An event monitoring model 912 may be applied to different groups of IoT nodes 908 in an IoT network 906. For example, a third event monitoring model 912c may be applied to a first intra-IoT group. A fourth event monitoring model 912d may be applied to a second intra-IoT group.

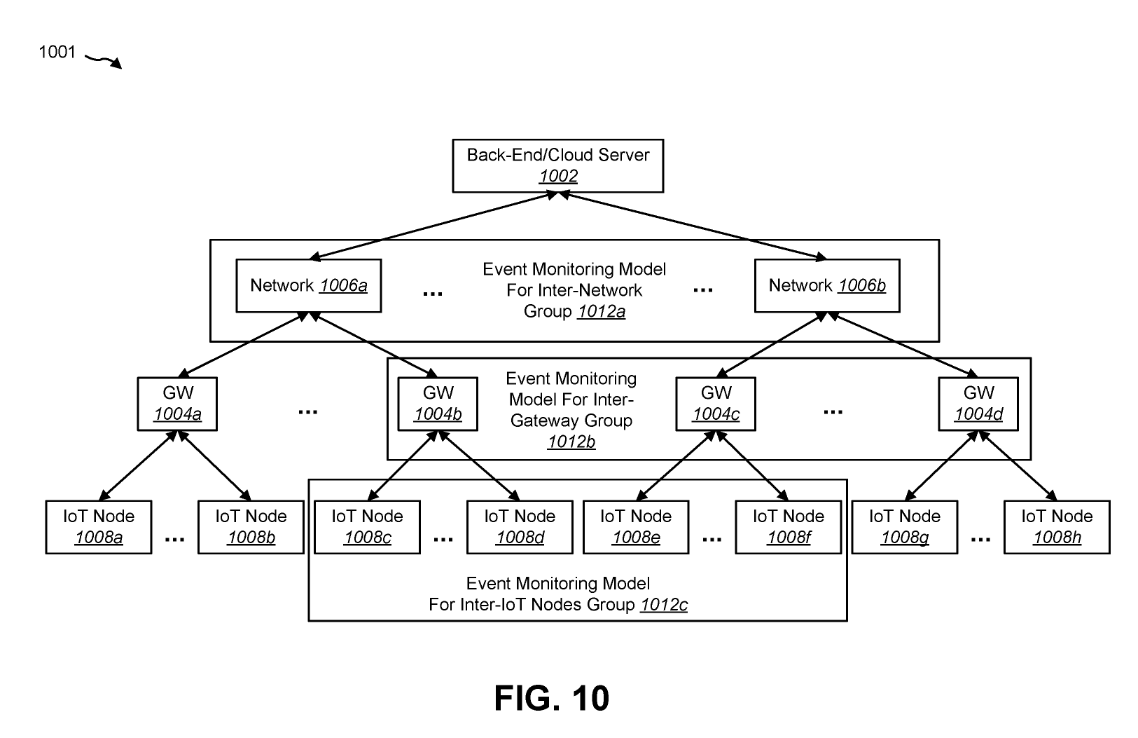

FIG. 10 is an example illustrating a third event monitoring model configuration 1001. A back-end/cloud server 1002 may communicate with multiple networks 1006a-b. A first network 1006a may include multiple gateways 1004a-b that communicate with one or more IoT nodes 1008a-d. A second network 1006b may include multiple gateways 1004c-d that communicate with one or more IoT nodes 1008e-h.

Event monitoring models 1012 can be learning and applied across subsets of network devices. For example, a first event monitoring model 1012a may be applied to a first network group. A second event monitoring model 1012b may be applied to different groups of gateways (GW) 1004 across IoT networks 1006. A third event monitoring model 1012c may be applied to different groups of IoT nodes 1008 across IoT networks 1006.

FIG. 11 is a block diagram illustrating one configuration of a feature extractor 1117. A data management module 1176 may receive data from a data source 1174. For example, the data source 1174 may be network traffic 222. The data management module 1176 may provide the data to a data aggregation module 1178, which may store a certain amount to received data. A data frame module 1180 may determine how to frame the data stored by the data aggregation module 1178.

At the end of a data frame 1180, the received data may be provided to feature extraction methods 1186 based on the use case of interest. Different use cases include security, home automation, energy management, automotive, etc. A use case may also depend on the type of network that is monitored. Some of the different types of networks that may benefit from network monitoring include Internet of Things (IoT) networks, industrial IoT (IIoT) networks, Automotive for Bluetooth, ZigBee, WiFi, CSR mesh, etc.

A use case selection module 1184 may select a use case from a use case database 1182. The feature extraction methods 1186 may extract machine learning features 1188 from the received data frame 1180. The same feature may be needed in multiple use cases.

A few key observations and features are source address, destination address, time and location contextual information, hop count, model and message type, data volume, throughput, connection time, delay in response, whitelist and message model matching.

In an example, a feature extractor 1117 may extract machine learning features 1188 for a CSR mesh network 106. A mesh network 106 has various application models that can be supported by a given node 108. The application model corresponds to the capabilities of a node 108. The node 108 can have any combination of these application models. For example, a node 108 can have both a light model and a sensor model for measuring the temperature for rooms.

Within each application model there are certain levels of attributes. For instance, the light, what the target level should be, how frequently a node 108 is switching are observable attributes. The traffic monitor 214 may determine whether a change in attribute is normal. For example, traffic monitor 214 may determine whether a node 108 is trying to overload the system in a denial of service attack by throwing more messages than it should because somebody has hacked the node 108.

One application model is a light model. Observable events 224 may include a current level, target level, and frequency of state change.

Another application model is a configuration (Config) model. Observable events 224 may include a transmit level (TransmitInterval), transmit duration (TransmitDuration), transmit interval (TxInterval), transmit power (TransmitPower), and receiver duty cycle (ReceiverDutyCycle).

Another application model is a sensor model. Observable events 224 may include a sensor write value and sensor value.

Another application model is an internal firmware watchdog model. Observable events 224 may include an Interval and ActiveAfterTime value.

Yet another application model is a battery model. Observable events 224 may include battery level, battery state and battery periodic behavior.

Other observable events 224 in a CSR mesh network 106 include a hop counter. This may include the hop distance of each of the nodes 108 from the gateway 104. This may also include the hop count of the neighborhood topology.

Observable events 224 may also include MASP information. For example, the number of MASP_DEVICE_IDENTIFICATION messages in a certain period may be observed. Also the number of association timeouts may be observed.

Observable events 224 may also include a tracker model. In this case, the observable events 224 may include zone threshold and a delay factor in the Tracket_SET_Proximity_Config.

Observable events 224 may also include the message load. In this case, the observable events 224 may include the number of messages forwarded, the duration of turned on and the reset history.

Examples of the feature extraction methods 1186 that may be applied to the received data include one or more of the following: get IDs, get time stamp, get tunnel identifier (TID), get model name, get Time-to-live (TTL) value, get source sequence number, get whitelist mismatch, check whitelist mismatch, get model ID, get total packet count information, check model mismatch, get total packet count information and query feature buffer.

The machine learning features 1188 generated by the feature extraction methods 1186 may include one or more of the following machine learning feature vectors: source universally unique identifier (UUID), destination UUID, gateway ID, network ID Network type, event time, TID, model name, TTL, source sequence number, whitelist mismatch, model ID, total number of packets, model mismatch, number of packets per model, number of packets in a window and number of packets per model in a window.

It should be noted that in other mesh networks (e.g., ZigBee), there are similar concepts as in a CSR mesh network where device events 224 can be observed. For example, users can send commands to a device through its protocol to turn a device on, off or toggle (e.g. switch). These events may be monitored, translated from their respective protocol and normalized for the purpose of analysis. The event monitoring models 212 for anomaly detection may be applied irrespective of whether the event occurs in a CSR mesh network, a ZigBee network or other mesh network 106. In other solution domains such as the Smart Energy Profile under ZigBee, energy usage may be observed from various types of devices such as smart appliances, heating, ventilation and air conditioning (HVAC), exterior lighting, interior lighting, etc.

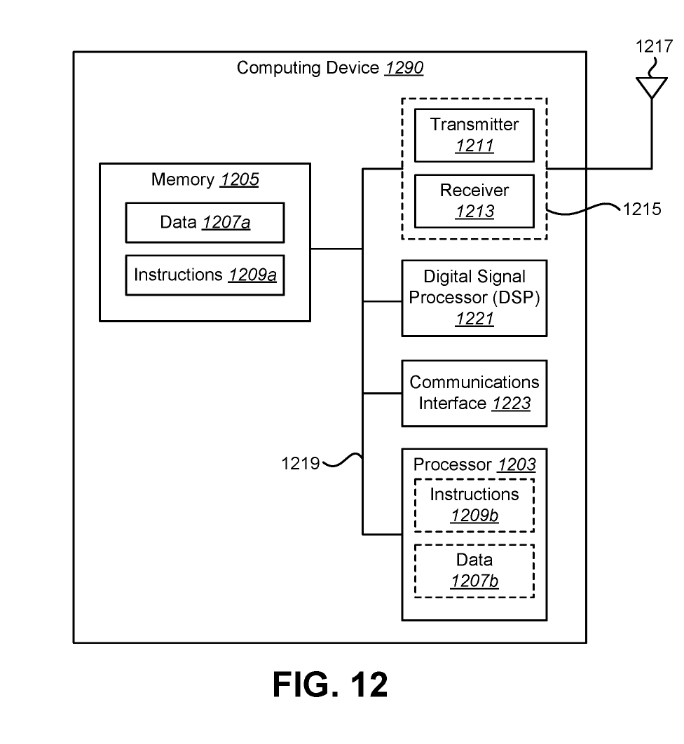

FIG. 12 illustrates certain components that may be included within a computing device 1290. The computing device 1290 described in connection with FIG. 12 may be an example of and/or may be implemented in accordance with the back-end server 102 and gateways 104 described in connection with FIG. 1 and the traffic monitor 214 and machine learning engine 210 described in connection with FIG. 2.

The computing device 1290 includes a processor 1203. The processor 1203 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1203 may be referred to as a central processing unit (CPU). Although just a single processor 1203 is shown in the computing device 1290 of FIG. 12, in an alternative configuration, a combination of processors (e.g., an ARM and DSP) could be used.

The computing device 1290 also includes memory 1205 in electronic communication with the processor 1203 (i.e., the processor can read information from and/or write information to the memory). The memory 1205 may be any electronic component capable of storing electronic information. The memory 1205 may be configured as Random Access Memory (RAM), Read-Only Memory (ROM), magnetic disk storage media, optical storage media, flash memory devices in RAM, on-board memory included with the processor, Erasable Programmable Read-Only Memory (EPROM), Electrically Erasable Programmable Read-Only Memory (EEPROM), registers and so forth, including combinations thereof.

Data 1207a and instructions 1209a may be stored in the memory 1205. The instructions 1209a may include one or more programs, routines, sub-routines, functions, procedures, code, etc. The instructions 1209a may include a single computer-readable statement or many computer-readable statements. The instructions 1209a may be executable by the processor 1203 to implement the methods disclosed herein. Executing the instructions 1209a may involve the use of the data 1207a that is stored in the memory 1205. When the processor 1203 executes the instructions 1209, various portions of the instructions 1209b may be loaded onto the processor 1203, and various pieces of data 1207b may be loaded onto the processor 1203.

The computing device 1290 may also include a transmitter 1211 and a receiver 1213 to allow transmission and reception of signals to and from the computing device 1290 via an antenna 1217. The transmitter 1211 and receiver 1213 may be collectively referred to as a transceiver 1215. The computing device 1290 may also include (not shown) multiple transmitters, multiple antennas, multiple receivers and/or multiple transceivers.

The computing device 1290 may include a digital signal processor (DSP) 1221. The computing device 1290 may also include a communications interface 1223. The communications interface 1223 may allow a user to interact with the computing device 1290.

The various components of the computing device 1290 may be coupled together by one or more buses, which may include a power bus, a control signal bus, a status signal bus, a data bus, etc. For the sake of clarity, the various buses are illustrated in FIG. 12 as a bus system 1219.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, comprising:
receiving an event monitoring model generated by a machine learning engine, wherein the event monitoring model is configured to classify network device behavior based on observed events;
monitoring events in a network based on the event monitoring model, wherein machine learning features are extracted from network traffic generated by one or more network devices;
determining a network device classification of the monitored events based on the event monitoring model; and
sending the observed events and the network device classification to the machine learning engine to update the event monitoring model.

2. The method of claim 1, wherein the machine learning engine receives observed events and network device classifications from a plurality of network devices.

3. The method of claim 2, wherein the machine learning engine learns and generates the event monitoring model based on the observed events and the network device classifications received from the plurality of network devices.

4. The method of claim 2, wherein the machine learning engine uses the observed events and the network device classifications received from the plurality of network devices to perform semi-supervised learning to generate the event monitoring model.

5. The method of claim 1, wherein the machine learning engine learns and generates the event monitoring model for a subset of network devices to be monitored.

6. The method of claim 1, wherein the machine learning engine applies the event monitoring model across a group of networks, a group of gateways or a group of nodes within a network.

7. The method of claim 1, further comprising applying different machine learning models to different sections of a network.

8. The method of claim 1, wherein the machine learning engine runs multiple machine learning algorithms sequentially to generate the event monitoring model for a network device or a group of network devices.

9. The method of claim 1, wherein the machine learning engine generates different event monitoring models for different network devices or a same network device with different time information using a same machine learning algorithm with different parameters.

10. The method of claim 1, wherein the event monitoring model configures which events are monitored and which machine learning features are extracted from the monitored events.

11. The method of claim 1, further comprising:
receiving an updated event monitoring model in response to sending the observed events and the network device classification to the machine learning engine; and
monitoring events in the network based on the updated event monitoring model.

12. The method of claim 1, further comprising:
receiving a plurality of event monitoring models from the machine learning engine, wherein a given event monitoring model configures monitoring of events on a certain subset of network devices; and
monitoring events in a network based on the plurality of event monitoring models.

13. The method of claim 1, wherein monitoring events comprises observing network traffic communicated between nodes or network traffic communicated between a node and a gateway.

14. The method of claim 1, wherein monitoring events comprises:
sending a network query to a given network device;
observing actions taken by the given network device in response to the network query; and
determining the network device classification of the given network device by applying the event monitoring model to the observed actions.

15. The method of claim 1, wherein the method is implemented at a gateway or a cloud server that receives a traffic feed from a plurality of nodes.

16. The method of claim 1, further comprising limiting behavior of a network device that is classified as rogue or suspicious.

17. A computing device, comprising:
a processor;
a memory in communication with the processor; and
instructions stored in the memory, the instructions executable by the processor to:
receive an event monitoring model generated by a machine learning engine, wherein the event monitoring model is configured to classify network device behavior based on observed events;
monitor events in a network based on the event monitoring model, wherein machine learning features are extracted from network traffic generated by one or more network devices;
determine a network device classification of the monitored events based on the event monitoring model; and
send the observed events and the network device classification to the machine learning engine to update the event monitoring model.

18. The computing device of claim 17, wherein the machine learning engine receives observed events and network device classifications from a plurality of network devices.

19. The computing device of claim 18, wherein the machine learning engine learns and generates the event monitoring model based on the observed events and the network device classifications received from the plurality of network devices.

20. The computing device of claim 18, wherein the machine learning engine uses the observed events and the network device classifications received from the plurality of network devices to perform semi-supervised learning to generate the event monitoring model.

21. The computing device of claim 17, wherein the event monitoring model configures which events are monitored and which machine learning features are extracted from the monitored events.

22. The computing device of claim 17, further comprising instructions executable to:
receive an updated event monitoring model in response to sending the observed events and the network device classification to the machine learning engine; and
monitor events in the network based on the updated event monitoring model.

23. The computing device of claim 17, further comprising instructions executable to:
receive a plurality of event monitoring models from the machine learning engine, wherein a given event monitoring model configures monitoring of events on a certain subset of network devices; and
monitor events in a network based on the plurality of event monitoring models.

24. The computing device of claim 17, wherein the instructions executable to monitor events comprise instructions executable to observe network traffic communicated between nodes or network traffic communicated between a node and a gateway.

25. The computing device of claim 17, wherein the instructions executable to monitor events comprise instructions executable to
send a network query to a given network device;
observe actions taken by the given network device in response to the network query; and
determine the network device classification of the given network device by applying the event monitoring model to the observed actions.

26. A non-transitory tangible computer readable medium storing computer executable code, comprising:
code for causing a computing device to receive an event monitoring model generated by a machine learning engine, wherein the event monitoring model is configured to classify network device behavior based on observed events;
code for causing the computing device to monitor events in a network based on the event monitoring model, wherein machine learning features are extracted from network traffic generated by one or more network devices;
code for causing the computing device to determine a network device classification of the monitored events based on the event monitoring model; and
code for causing the computing device to send the observed events and the network device classification to the machine learning engine to update the event monitoring model.

27. The computer readable medium of claim 26, wherein the machine learning engine receives observed events and network device classifications from a plurality of network devices.

28. The computer readable medium of claim 27, wherein the machine learning engine learns and generates the event monitoring model based on the observed events and the network device classifications received from the plurality of network devices.

29. The computer readable medium of claim 27, wherein the machine learning engine uses the observed events and the network device classifications received from the plurality of network devices to perform semi-supervised learning to generate the event monitoring model.

30. The computer readable medium of claim 26, wherein the event monitoring model configures which events are monitored and which machine learning features are extracted from the monitored events.

31. The computer readable medium of claim 26, wherein the computer executable code further comprises:
code for causing the computing device to receive an updated event monitoring model in response to sending the observed events and the network device classification to the machine learning engine; and
code for causing the computing device to monitor events in the network based on the updated event monitoring model.

32. The computer readable medium of claim 26, wherein the computer executable code further comprises:
code for causing the computing device to receive a plurality of event monitoring models from the machine learning engine, wherein a given event monitoring model configures monitoring of events on a certain subset of network devices; and
code for causing the computing device to monitor events in a network based on the plurality of event monitoring models.

33. The computer readable medium of claim 26, wherein the code for causing the computing device to monitor events comprises code for causing the computing device to observe network traffic communicated between nodes or network traffic communicated between a node and a gateway.

34. The computer readable medium of claim 26, wherein the code for causing the computing device to monitor events comprises:
code for causing the computing device to send a network query to a given network device;
code for causing the computing device to observe actions taken by the given network device in response to the network query; and
code for causing the computing device to determine the network device classification of the given network device by applying the event monitoring model to the observed actions.

35. An apparatus, comprising:
means for receiving an event monitoring model generated by a machine learning engine, wherein the event monitoring model is configured to classify network device behavior based on observed events;
means for monitoring events in a network based on the event monitoring model, wherein machine learning features are extracted from network traffic generated by one or more network devices;
means for determining a network device classification of the monitored events based on the event monitoring model; and
means for sending the observed events and the network device classification to the machine learning engine to update the event monitoring model.

36. The apparatus of claim 35, wherein the machine learning engine receives observed events and network device classifications from a plurality of network devices.

37. The apparatus of claim 36, wherein the machine learning engine learns and generates the event monitoring model based on the observed events and the network device classifications received from the plurality of network devices.

38. The apparatus of claim 35, wherein the event monitoring model configures which events are monitored and which machine learning features are extracted from the monitored events.

39. The apparatus of claim 35, further comprising:
means for receiving an updated event monitoring model in response to sending the observed events and the network device classification to the machine learning engine; and
means for monitoring events in the network based on the updated event monitoring model.

40. The apparatus of claim 35, further comprising:
means for receiving a plurality of event monitoring models from the machine learning engine, wherein a given event monitoring model configures monitoring of events on a certain subset of network devices; and
means for monitoring events in a network based on the plurality of event monitoring models.

41. The apparatus of claim 35, wherein the means for monitoring events comprise means for observing network traffic communicated between nodes or network traffic communicated between a node and a gateway.

42. The apparatus of claim 35, wherein the means for monitoring events comprise:
means for sending a network query to a given network device;
means for observing actions taken by the given network device in response to the network query; and
means for determining the network device classification of the given network device by applying the event monitoring model to the observed actions.
